(19) United States
(12) Patent Application Publication
(10) Pub. No.: US 2011/0238445 A1
(43) Pub. Date: Sep. 29, 2011

(54) STUDY-CONNECT METHODS AND SYSTEMS

(76) Inventor: Mike Woods, Missoula, MT (US)

(21) Appl. No.: 13/072,063

(22) Filed: Mar. 25, 2011

Related U.S. Application Data
(60) Provisional application No. 61/318,211, filed on Mar. 26, 2010.

(51) Int. Cl. G06Q 50/00; G06Q 10/00

(52) U.S. Cl. 705/3; 705/2

(57) ABSTRACT

Medical tests are entered and automatically tracked through. A health care provider (HCP) can enter an order for a patient's medical test. A back office assistant (BOA) can review or amend an order already entered into a data processing system or can process the order to thereby enter it into the computer. The order is automatically passed to a testing facility where it is scheduled. The test time can be communicated the BOA, HCP, or patient. The BOA can be alerted when the test time approaches such that pretest instructions can be communicated with the patient. The BOA can obtain the test results, store them in a database, and inform the HCP that the test results are ready for review. The HCP can then review the test results, decide what further action is required, and report the results back to the patient or the referring HCP.

### CROSS REFERENCE TO RELATED APPLICATIONS

This patent application claims the priority and benefit of U.S. provisional patent application 61/318,211 filed on Mar. 26, 2010 entitled “Study-Connect Methods and Systems” which is herein incorporated by reference.

### TECHNICAL FIELD

Embodiments relate to the fields of medical tests, medical test data, and electronic health records. Embodiments also relate to the fields of electronic data processing systems, computer networks, and databases.

### BACKGROUND

Current medical data systems provide database systems that can store patient information, health records, and charts. The current systems are not well provisioned, however, for tracking scheduled events, coordinating activities, or ensuring accurate reporting and follow up—especially when multiple facilities or disparate organizations are involved. Therefore systems and methods for tracking scheduled events, coordinating activities, or ensuring accurate reporting and follow up are needed.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

A health care provider (HCP), such as a doctor, nurse, medical assistant, or other provider of health care services can perceive the need for a medical test while examining a patient. The HCP can enter test order data into a user interface. A back office assistant (BOA) can review or edit the test order data. For example, the BOA can add in patient data, specify a testing facility, or ensure proper billing codes. The test order data can be automatically transmitted to the testing facility and the medical test is scheduled.

The time and date for the medical test can then be automatically sent to the patient and the BOA. The BOA typically receives information at the workplace and on the computer system used there, but other means are sometimes used. The patient, however, can be alerted by a variety of means such as email, text message, letter, or auto-generated phone call. The precise mean or means can be selected by the patient and recorded with the patient's other data.

When the time for the test is near, the BOA can be alerted to communicate pretest instructions with the patient. This is typically done via telephone or a scheduled office visit so that the BOA can be sure that the patient understands the instructions. The medical test can then be performed and test results obtained. The BOA can be automatically informed that the test results are available at which time the BOA can ensure that the HCP can access the test results. For example, the BOA can download the test results into a data processing system to which the HCP has access. The HCP can then examine the test results, determine a course of action, and select that course of action on another user interface.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention.

FIG. 1 illustrates a portion of a high level flow diagram for a study-connect process in accordance with aspects of the embodiments;

FIG. 2 illustrates another portion of the high level flow diagram for a study-connect process in accordance with aspects of the embodiments; and

FIG. 3 illustrates a user interface into which a post test action can be entered in accordance with aspects of the embodiments.

### DETAILED DESCRIPTION

The particular values and configurations discussed in these non-limiting examples can be varied and are cited merely to illustrate at least one embodiment and are not intended to limit the scope thereof. In general, the figures are not to scale.

Medical tests are entered and automatically tracked through completion and reporting back to a health care provider (HCP). The health care provider enters an order for a medical test for a patient. A back office assistant BOA can review or amend an order already entered into a data processing system or the BOA can process the order to thereby enter it into the computer. The order is automatically passed to a testing facility where it is scheduled and the test time communicated back to the BOA or HCP and patient. The BOA can be alerted when the test time approaches such that pretest instructions can be communicated with the patient. The BOA can obtain the test results, store them in a database, and inform the HCP that the test results are ready for review.

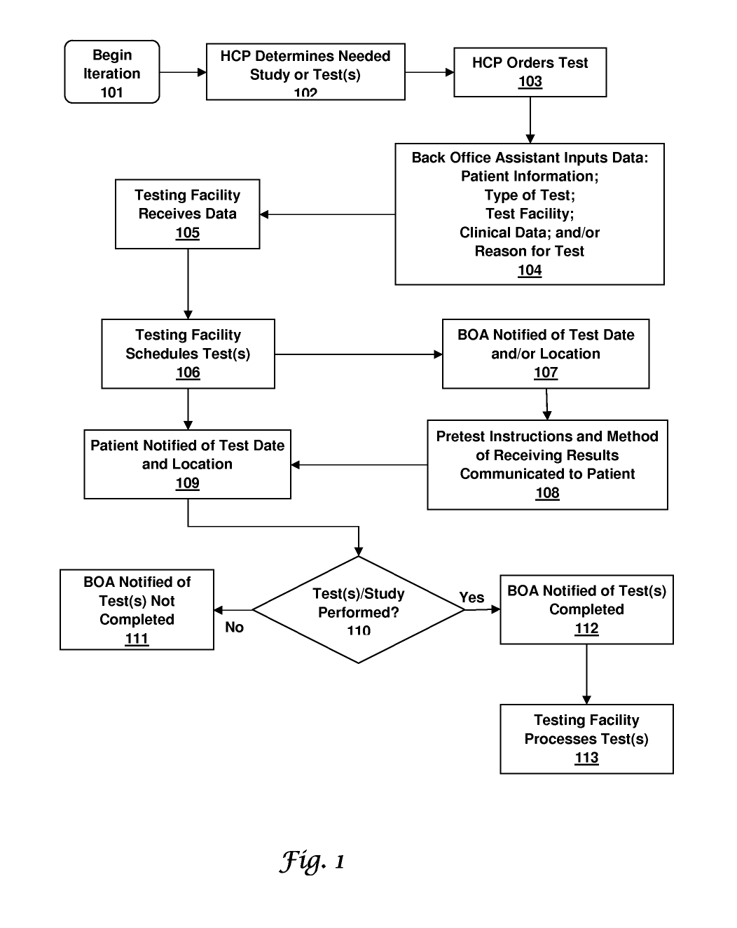

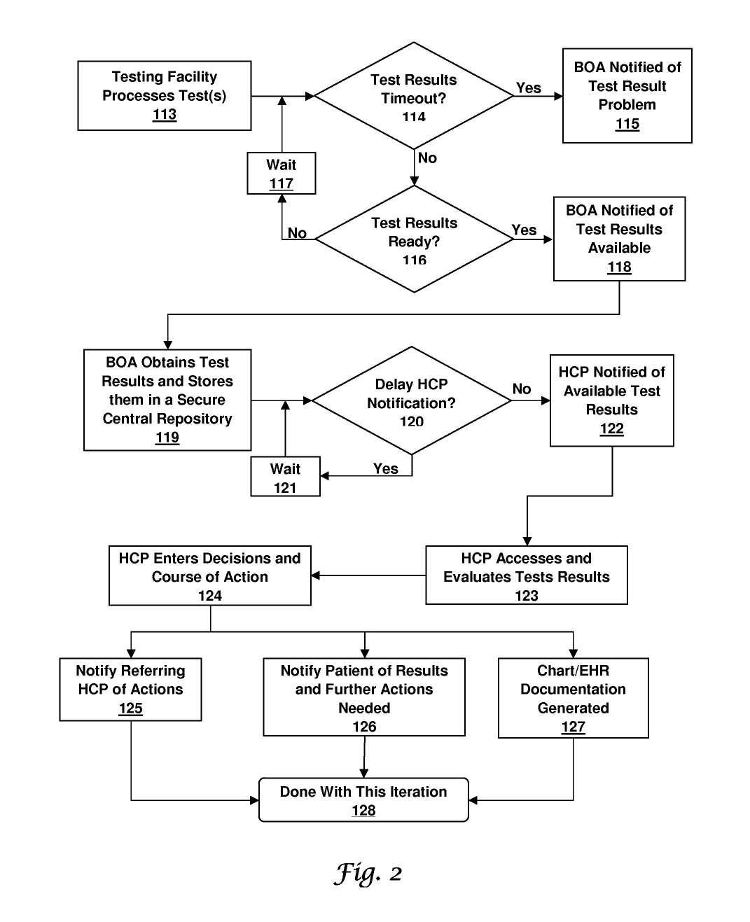

FIGS. 1 and 2 illustrate a high level flow diagram for a study-connect process in accordance with aspects of the embodiments. An iteration begins 101 when a health care provider (HCP) examines a patient or a previous test result and determines that a medical test is needed 102. The HCP orders the test 103. The HCP can enter an order for the test directly into a user interface to a Study-Connect enabled system or can otherwise communicate the needed test to a back office assistant (BOA). The back office assistant can ensure that the test is properly entered and ordered with the appropriate patient information, type of test, testing facility, clinical data, and/or reason for the test 104.

The Study-Connect can automatically transmit the test data to the testing facility 105 where it is scheduled 106 and the Study-Connect system can also automatically send the test time, date and location information to the patient 109 and the BOA 107. When the test time nears the BOA can communicate with the patient to ensure that any pretest instructions and understood and to ensure that the patient's desired ways of receiving the test results are entered 108.

The pretest instructions can include details and directives to guide the patient in preparation for the test. For example, the patient may need to fast for a period before the test, may need to ensure transport from the test location after the test, or other information.

The BOA can also receive the test date, time, location, and pretest instructions. Furthermore, a ‘tickler’ can be automatically loaded into the assistant's schedule. The tickler can remind the assistant to contact the patient before the test to ensure that the patient has received the test details and to address the patient's questions or other matters. For example, the assistant can ensure the patient understands the patient instructions and can note how the patient would prefer to receive any test results.

The testing location information can be communicated to the patient in a variety of ways and can contain mapping information. For example, if the patient is informed electronically (by email, text message, or similar means) the mapping information can contain a map graphic or a mapping link. A map graphic can be an image of a map such as those generated by MapQuest, Google Maps, or a similar mapping service. A map link can be a web link that when followed goes to a mapping service such that the map is automatically generated.

Ideally, the patient then follows the patient instructions and reports to the testing location on time. The test can then be performed as ordered and scheduled. The Study-Connect system or the BOA can be informed 111 if the test is not performed 110 or if the test is completed 112 then the testing facility can process the test 113. The Study-Connect system can wait for the test results. If too much time has elapsed 114 then the BOA can be alerted that there is a problem in producing the test result 115. If too much time hasn't elapsed 114 and the test results are not ready 116, then waiting can continue. If the results are ready 116, the BOA can be so notified 118. The BOA can then obtain the test results and store them in a central repository 119 such as a database that can be part of the Study-Connect system or with which the Study-Connect system is interconnected or integrated to some degree. Regardless, the BOA can download the test results into a local database to which both the BOA and the HCP have access.

In many cases the HCP will have ordered numerous medical tests and those test may have been performed at a variety of testing facilities. In those cases, the patient would have been informed of the various locations, times, and pretest instructions. Furthermore, the Study-Connect system can be configured to delay notification of the doctor or assistant until all the test results are available, until a subset of the results are available, as each test result comes available, that test results remain unavailable after a given time period or date, or some other notification criteria. These notification preferences are reflected in the flow diagram wherein the system waits 121 until it is decided 120 to notify the HCP 122. Note that the time-out notification can be used when no test result is available after too much time has elapsed since a single test has been ordered.

Regardless of the number of medical tests performed, the test results can all be made available to the HCP for viewing, downloading, or otherwise obtaining the test results. The test data, as well as all other patient data and information, should be stored securely, be properly backed up, and be retrievable by those properly authorized. For example, the assistant or doctor can have password protected access to the patient's data and information. The patient's data and information can be stored under the patients name or otherwise indexed in a database in association with a unique patient identifier or set of identifiers that collectively identify the patient uniquely.

After accessing and evaluating the test results 123 the HCP can enter observations, decisions, and desired courses of action into the Study-Connect system 124. Those courses of action can include notifying the referring HCP of the actions 125 and notifying the patient of the test results and what further actions are needed 126. Furthermore, charts and electronic health records can be generated, perhaps automatically, and can be stored in the database with the other patient information.

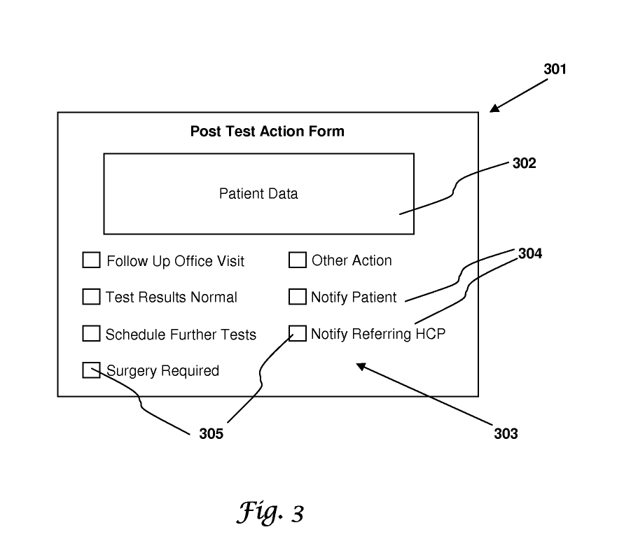

FIG. 3 illustrates a user interface into which a post test action can be entered in accordance with aspects of the embodiments 301. One area of the form can contain patient information 302. Another area of the form 303 can provide the HCP with a means to select a course of action. For example, a number of check boxes 305 with labels 304 can allow the HCP to select one or more actions to be selected and entered into the Study-Connect system.

Embodiments can be implemented in the context of modules. In the computer programming arts, a module can be typically implemented as a collection of routines and data structures that performs particular tasks or implements a particular abstract data type. Modules generally can be composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method comprising:
providing a user interface to a health care provider wherein the health care provider uses the user interface to enter test order data into a data processing system,
wherein the test order data specifies a plurality of medical tests for a patient to be performed at one or more testing facilities,
wherein the test order data is automatically transmitted to the testing facilities,
wherein the medical tests are scheduled to be performed at one or more testing time,
wherein the patient is automatically notified of the testing times,
wherein an assistant of the health care provider is automatically notified of the testing times,
wherein the assistant communicates pretest instructions to the patient,
wherein at least one of the medical tests is performed as scheduled to thereby produce at least one test result, and
wherein the assistant is automatically informed that the at least one test result is available.

2. The method of claim 1,
wherein the at least one of the medical tests is all of the medical tests,
wherein the assistant wait until all of the test results are available, and
wherein the assistant informs the health care provider that test results for all of the medical tests are available.

3. The method of claim 1,
wherein one of the medical tests is not performed as scheduled,
wherein the assistant is automatically notified of an unperformed medical test, and
wherein the assistant informs the health care provider that the at least one test result is available and that one of the medical tests is not performed as scheduled.

4. The method of claim 3 wherein the test results are stored in a database.

5. The method of claim 4 wherein security and access controls limit access to the database and wherein the assistant and the health care provider have access to the database.

6. The method of claim 4 wherein the health care provider has access to the database and examines the test results.

7. The method of claim 6 further comprising providing an additional user interface to the health care provider wherein the health care provider uses the additional user interface to select a post test action.

8. The method of claim 7 wherein the post test action comprises at least one of: ordering another medical test, notifying the patient of the test result, notifying a referring health care provider, or scheduling a follow up office visit.

9. A method comprising:
providing a user interface to a health care provider wherein the health care provider uses the user interface to enter test order data into a data processing system,
wherein the test order data specifies a medical test for a patient to be performed at a testing facility,
wherein the test order data is automatically transmitted to the testing facility,
wherein the medical test is scheduled to be performed at a testing time,
wherein the patient and an assistant of the health care provider are automatically notified of the testing time,
wherein the assistant communicates pretest instructions to the patient,
wherein the medical test is performed as scheduled to thereby produce test results,
wherein the assistant is automatically informed that the test results are available,
wherein the assistant obtains the test results and stores them in a database, and
wherein the health care provider has access the database and examines the test results.

10. The method of claim 9 further comprising providing an additional user interface to the health care provider wherein the health care provider uses the additional user interface to select a post test action.

11. A method comprising:
providing a user interface to a health care provider wherein the health care provider uses the user interface to enter test order data into a data processing system,
wherein the test order data specifies a medical test for a patient to be performed at a testing facility,
wherein the test order data is automatically transmitted to the testing facility,
wherein the medical test is scheduled to be performed at a testing time, and
wherein the patient is automatically notified of the testing time.

12. The method of claim 11 wherein an assistant of the health care provider is automatically notified of the testing time and wherein the assistant communicates pretest instructions to the patient.

13. The method of claim 11 wherein the medical test is not performed as scheduled and the assistant is automatically notified of the test being not performed.

14. The method of claim 11 wherein the medical test is performed as scheduled to thereby produce test results and wherein the assistant is automatically informed that the test results are available.

15. The method of claim 14 wherein the test results are stored in a database.

16. The method of claim 15 wherein security and access controls limit access to the database and wherein the assistant and the health care provider have access to the database.

17. The method of claim 16 wherein the health care provider has access the database and examines the test results.

18. The method of claim 17 further comprising providing an additional user interface to the health care provider wherein the health care provider uses the additional user interface to select a post test action.

19. The method of claim 18 wherein the post test action comprises at least one of ordering another further medical test, notifying the patient of the test result, notifying a referring health care provider, or scheduling a follow up office visit.

20. The method of claim 15 wherein the health care provider has access the database and examines the test results and further comprising providing an additional user interface to the health care provider wherein the health care provider uses the additional user interface to select a post test action comprising at least one of ordering another further medical test, notifying the patient of the test result, notifying a referring health care provider, or scheduling a follow up office visit.
